(19) United States
(12) Patent Application Publication
(10) Pub. No.: US 2024/0158140 A1
(43) Pub. Date: May 16, 2024

(54) REUSABLE STORAGE CONTAINER

(71) Applicant: GOURMET HOME PRODUCTS, LLC, New York, NY (US)

(72) Inventor: Jack SAADEH, New York, NY (US)

(21) Appl. No.: 18/509,076

(22) Filed: Nov. 14, 2023

Related U.S. Application Data
(60) Provisional application No. 63/425,567, filed on Nov. 15, 2022.

(51) Int. Cl. B65D 47/12; B65D 43/02; B65D 51/18; B65D 51/24

(52) U.S. Cl. CPC B65D 47/122; B65D 43/0231; B65D 51/18; B65D 51/245; B65D 2203/02; B65D 2251/0015; B65D 2251/0081; B65D 2543/00537

(57) ABSTRACT

A storage container and method of using the storage container is disclosed. In one embodiment, the storage container includes a lower portion that defines a first opening and can hold a liquid. The storage container includes an upper portion that defines a second opening and is received by and in fluid communication with lower portion. The storage container includes a spout that extends from the upper portion and at least a portion of the liquid can be poured from the spout.

### CROSS REFERENCE TO RELATED APPLICATIONS

This application claims priority to and the benefit of U.S. Provisional Patent Application No. 63/425,567 filed 15 Nov. 2022 and titled “REUSABLE STORAGE CONTAINER”, which is hereby incorporated by reference in its entirety for all purposes.

### FIELD

This application relates to storage containers and methods of using storage containers.

### BACKGROUND

Many consumables, such as food and drinks, should preferably be stored in a container. For example, the containers can be stored in a refrigerator so that the growth of bacteria associated with the consumable is slowed. This can extend the freshness and quality of the consumable compared to if the consumable was stored at a higher temperature, e.g., room temperature.

Loading the consumable into the container can be a challenge because spills and messes are common. A separate tool, such as a funnel, is typically required to load a consumable into a storage container. Additionally, many storage containers, such as milk cartons require a specific and separate machine to load the milk during the production process. Due to these limitations in the field, the container may comprise a single large hole to minimize spills and the need for a separate tool during the loading process. However, a container with a large hole to load the consumable can make dispensing the stored consumable a challenge. For example, if the user wishes to dispense the consumable e.g., to a different container, the user is typically required to dispense the consumable into an opening that is larger than the opening in the storage container or is required to use a separate tool, such as a funnel. Alternatively, the container can include a spigot to dispense the consumable.

However, relying on separate tools such as funnels can be time consuming and require the user to clean additional dishes. Additionally, containers with spigots can be inefficient as the container is required to be positioned with the spigot over an edge, the spigot inhibits other containers from being stored in close proximity to the container, and the flow rate the consumable is dispensed at decreases as more consumable is dispensed. Thus, improved methods and systems to provide a container that more efficiently stores and dispenses a consumable is needed.

### BRIEF SUMMARY

A storage container is disclosed. The storage container includes a lower portion that defines a first opening. The lower portion may hold a liquid. The storage container includes an upper portion that defines a second opening. The upper portion may be received by and in fluid communication with lower portion. The storage container includes a spout extending from the upper portion. With the upper portion and lower portion coupled together in an assembled configuration, at least a portion of the liquid may be poured from the spout of the storage container.

Optionally, in some embodiments, the first opening and the second opening are threaded openings.

Optionally, in some embodiments, the storage container includes a cap, such as a removable cap. The cap may cover the spout to prevent the liquid from pouring through the spout.

Optionally, in some embodiments, the storage container includes a customization surface. The customization surface may be located on at least one of the upper portion and the lower portion. The customization surface may display information related to the liquid.

Optionally, in some embodiments, the storage container is reusable and the lower portion may receive a different liquid.

Optionally, in some embodiments, the lower portion may receive the liquid via the first opening. The upper portion may dispense the liquid via the spout. And the first opening may be larger than the spout.

Optionally, in some embodiments, the first opening may be larger than the spout. The storage container may be manipulateable between a first use and a second use. The first use may be defined as: the lower portion may receive the liquid via the first opening with the upper portion uncoupled from the lower portion. The second use may be defined as: the upper portion may dispense the liquid via the spout with the upper portion coupled with the lower portion.

Optionally, in some embodiments, the storage container may be manipulateable between a load configuration and a storage configuration. The load configuration may be defined as: the lower portion may receive a liquid via the first opening with the upper portion uncoupled from the lower portion. The storage configuration may be defined as: the upper portion is coupled with the lower portion.

A reusable storage container is disclosed. The reusable storage container includes a lower portion. The lower portion may define a first opening to receive a liquid. The reusable storage container includes an upper portion to couple with the lower portion. The upper portion may define a second opening in fluid communication with the first opening. The second opening may dispense the liquid.

Optionally, in some embodiments, the reusable storage container may be manipulateable between a first use and a second use. The first use may be defined as: the reusable storage container may receive the liquid in the lower portion via the first opening. The second use may be defined as: the reusable storage container may dispense the liquid via a spout extending from the upper portion.

Optionally, in some embodiments, the reusable storage container may be manipulateable between a load configuration and a storage configuration. The load configuration may be defined as: the lower portion may receive a liquid via the first opening. The storage configuration may be defined as: the upper portion is coupled with the lower portion with at least a portion of the liquid stored within the lower portion.

Optionally, in some embodiments, the reusable storage container may include a spout. The spout may extend from the upper portion. The spout may allow fluid communication between the second opening and the first opening. Additionally in some embodiments, at least a portion of the liquid may be poured from the spout of the storage container.

Optionally, in some embodiments, the reusable storage container may include a cap. The cap may cover the spout with the reusable storage container in a storage configuration. The storage configuration may be defined as: at least a portion of the liquid is stored within the lower portion.

A method of using a storage container is disclosed. The method includes loading a lower portion of the storage container with a liquid. The liquid may be loaded via a first opening. The method includes coupling an upper portion of the storage container with the lower portion. The method includes pouring the liquid from the upper portion of the storage container.

Optionally, in some embodiments, the method may include, prior to loading the lower portion with the liquid, opening the lower portion. The lower portion may be opened via uncoupling the upper portion from the lower portion. Uncoupling the upper portion from the lower portion may expose the first opening.

Optionally, in some embodiments, the method may include storing the storage container in an environment with at least a portion of the liquid stored within the lower portion.

Optionally, in some embodiments, the method may include pouring the liquid from the storage container. The liquid may be poured from the storage container via a spout. The spout may extend from the upper portion.

Optionally, in some embodiments, the method may include customizing a customization surface. The customization surface may be of at least one of the upper portion and the lower portion. The customization may include information related to the liquid.

Additional embodiments and features are set forth in part in the description that follows, and will become apparent to those skilled in the art upon examination of the specification and may be learned by the practice of the disclosed subject matter. A further understanding of the nature and advantages of the present disclosure may be realized by reference to the remaining portions of the specification and the drawings, which form a part of this disclosure. One of skill in the art will understand that each of the various aspects and features of the disclosure may advantageously be used separately in some instances, or in combination with other aspects and features of the disclosure in other instances.

### BRIEF DESCRIPTION OF THE SEVERAL VIEWS OF THE DRAWINGS

FIG. 1 illustrates a storage container in an assembled configuration.

FIG. 2 illustrates the storage container in a disassembled configuration.

FIG. 3A illustrates the storage container in a load configuration.

FIG. 3B illustrates the storage container in a dispense configuration.

FIG. 4A illustrates the storage container in a storage configuration.

FIG. 4B illustrates the storage container in the storage configuration.

FIG. 4C illustrates the storage container in the storage configuration.

FIG. 5 illustrates a customization surface of the storage container.

FIG. 6 illustrates the storage container in the storage configuration in an example environment.

FIG. 7 illustrates a method of using the storage container.

### DETAILED DESCRIPTION

Systems and methods of storing a consumable are disclosed. The disclosed systems include a storage container. The storage container may include two portions, a lower portion and an upper portion. The consumable may be loaded into the lower portion via a first opening with the lower portion and the upper portion uncoupled. Then with the lower portion and the upper portion coupled, the consumable may be dispensed via a second opening defined by the upper portion and a spout extending from the upper portion. The lower portion opening may be larger than the spout, which is beneficial because the consumable may be loaded into the lower portion without additional tools such as a funnel. Additionally, since the spout is relatively smaller (e.g., compared to the lower portion opening) the consumable may be consumed and/or poured into a different container, e.g., a container for consumable consumption, more easily than if the spout was as large as the lower portion opening. For example, the consumable may be dispensed from the storage container without a separate tool, such as a funnel. Thus, the storage container provides a user with an efficient way to both load and dispense the consumable. Advantageously, the storage container is also reusable. It may be made of food grade plastic or other appropriate material and may be dishwasher safe and freezer safe.

In some embodiments, the upper portion may be positioned over the lower portion. With this “stacked” configuration of the storage container, the consumable may be efficiently stored in a refrigerator or similar storage environment without the need of a spigot that takes up additional storage space in the refrigerator. In some embodiments, with the storage container in a stored configuration the storage container may include a cap to cover the spout and prevent bacteria from contacting the consumable, spills, etc. The cap may be removed to dispense the consumable without the flow rate decreasing as rapidly as if it were dispensed from a spigot.

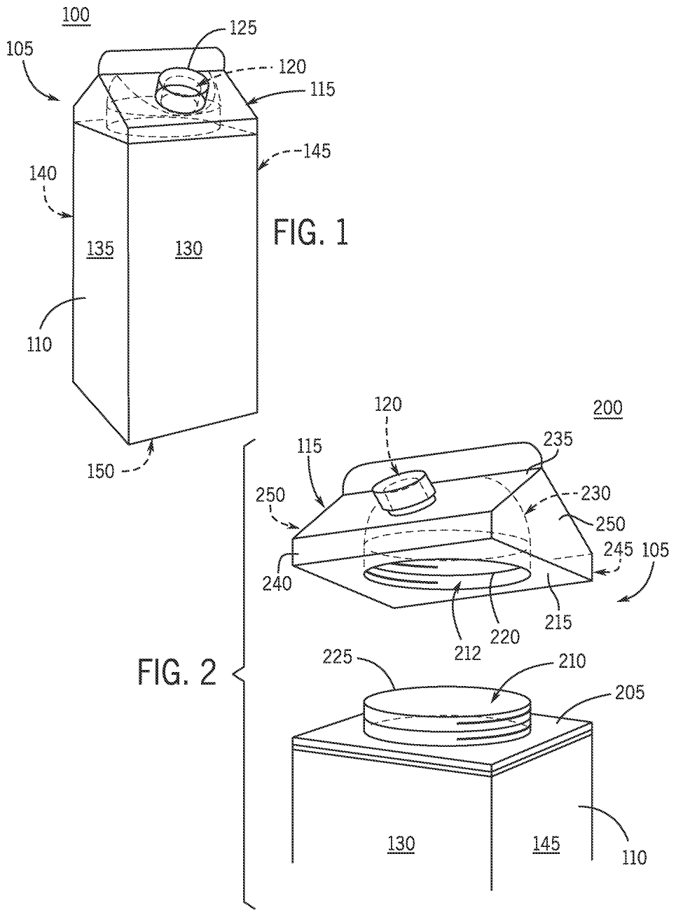

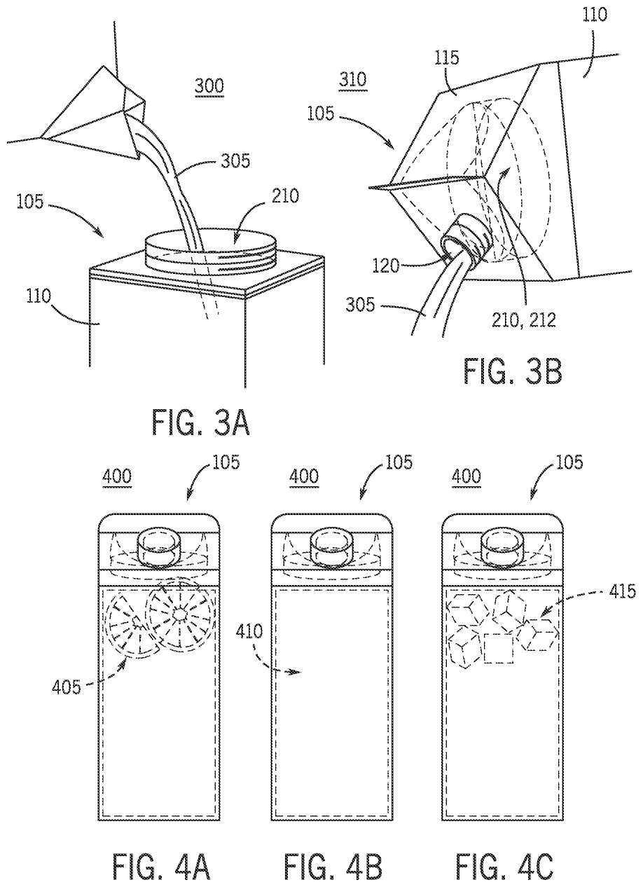

With reference to FIGS. 1 and 2, a storage container 105 is disclosed. In FIG. 1, the storage container 105 is depicted in an assembled configuration 100. In FIG. 2, the storage container 105 is depicted in a disassembled configuration 200. The storage container 105 may store a consumable 305, as depicted in FIG. 3A. For example, the storage container 105 may store greater than or equal to about 6 ounces and less than or equal to about 70 ounces of the consumable 305. The consumable 305 may be a liquid and/or a solid. For example, the consumable 305 may be an edible food and/or drink, e.g., the consumable 305 may be for human and/or animal consumption such as juice, water, milk, coffee, lemonade, tea, fruit for flavoring the water, soup which may have potatoes and meat, and the like. For example, the storage container 105 may store lemonade with the storage container 105 stored in a refrigerator. The storage container 105 and the components of the storage container 105, discussed herein, may be or may include any combination of food-grade plastic such as low-density polyethylene and polypropylene, cardboard, glass, silicone, double walled stainless steel, or the like. For example, the components of the storage container 105, discussed herein, may be clear or transparent or may include a slight coloring or may be completely opaque. The storage container 105 may be reusable. For example, the storage container 105 may be washed or otherwise disinfected (e.g. dishwasher safe) so as to remove the consumable 305 and a user may store another consumable in the storage container 105. Because the storage container 105 is reusable, the user may reduce waste because the user does not need to obtain a new storage container for every consumable stored.

The storage container 105 may include a lower portion 110, which may also be referred to as a body 110. The lower portion 110 may be formed from a plurality of panels. For example, the lower portion 110 may be formed from a front panel 130 and an opposing back panel 140; a first side panel 135 and an opposing second side panel 145; and a bottom panel 150 and an opposing top panel 205 (the top panel 205 may also be referred to as a lower portion surface 205 and a body surface 205). The panels 130, 135, 140, 145, 150, 205 may collectively form an internal compartment of the lower portion 110. The consumable 305 may be stored in the internal compartment of the lower portion 110. For example, the internal compartment of the lower portion 110 may hold 64 oz of liquid. In other embodiments, the internal compartment may hold up to greater than or equal to about 62 ounces and less than or equal to about 66 ounces of the consumable 305. In this configuration, the storage container 105 may hold multiple servings of the consumable 305.

The lower portion 110 may define a first opening 210. The first opening 210 may be defined by any of the panels 130, 135, 140, 145, 150, 205 of the lower portion 110. For example, the lower portion surface 205 (e.g., the top panel 205) may define the first opening 210. The first opening 210 may have a diameter between about (+/−10%) 1.5 inches and 4 inches. For example, the diameter of the first opening 210 may be 2 inches. The first opening 210 may be a threaded opening. Similarly, the lower portion 110 may include an attachment member 225 which may also be called a throat or a collar 225. For example, the lower portion surface 205 may include the attachment member 225. The attachment member 225 may extend from the lower portion surface 205. The attachment member 225 may define the first opening 210. The attachment member 225 may have a surface that is threaded. For example an external surface of the attachment member 225 may be threaded.

The storage container 105 may include an upper portion 115, which may also be referred to as a lid 115. The upper portion 115 may be any shape, e.g., a pyramid, a dome, a cube, or the like. For example, the upper portion 115 may resemble the top of a 64 oz milk or juice carton. The upper portion 115 may include a bottom panel 215, a top panel 235, a front panel 240 , a rear panel 245, and side panels 250, corresponding to the same panels 130, 135, 140, 145, 150, 205 of the lower portion. The upper portion 115 may define a second opening 212. The second opening 212 may be similar in size to the first opening 210 and may be configured for receipt by the first opening 210. For example, the second opening 212 may have a diameter that is slightly (+/−5%) larger than the diameter of the first opening 210 so as to snuggly fit over the first opening 210. The diameter of the second opening 212 may be between about (+/−10%) 1.5 inches and 4 inches. For example, the diameter of the second opening 212 may be 2.1 inches. The second opening 212 may be a threaded opening. Similar to the first opening 210, the second opening 212 may include an attachment surface 220, which may also be a collar or a throat. The attachment member 225 of the first opening 210 is configured to receive the attachment surface 220 of the second opening 212.

The storage container 105 may include a spout 120, e.g., a third opening 120. For example, the upper portion 115 may include the spout 120. The spout 120 may be or may define a hole and/or a channel in the upper portion 115. The spout 120 may extend from the upper portion 115. The spout 120 may also be at least partially inset from the upper portion 115. For example, a portion of the spout 120 may be partially inset from the upper portion 115 (e.g. extend below the top panel 235 of the upper portion 115) and another portion, e.g., a lip, of the spout 120 may extend from the upper portion 115 (e.g. extend above the top panel 235 of the upper portion). The spout 120 may have a diameter that is smaller than the first opening 210 and the second opening 212, e.g., the diameters of the openings 210, 212 may both be larger than the diameter of the spout 120. The diameter of the spout 120 may be between about (+/−10%) 0.5 inches and 2 inches. For example, the diameter of the spout 120 may be 1 inch. The spout 120 may include an external surface that is threaded and configured to receive a cap.

The storage container 105 may include a cap 125. The cap 125 may have a surface that is threaded. For example, an internal surface of the cap 125 may be threaded. The cap 125 may have a diameter that is slightly (+/−5%) larger than the diameter of the spout 120 so as to snuggly fit over the spout 120. The diameter of the cap 125 may be may be between about (+/−10%) 0.5 inches and 2 inches. For example, the diameter of the cap 125 may be 1.1 inches.

The upper portion 115 may define an internal space 230. The internal space 230 may be formed from any shape, e.g., a dome, a pyramid, a cube, or the like. For example, the internal space 230 may be formed from a dome shape within the upper portion 115 and the upper portion 115 may be a pyramid shape. In this configuration, the internal space 230 may be referred to as an internal dome 230. Additionally in this configuration, the bottom (e.g., in an operational orientation of the storage container 105) of the internal dome 230, may be formed by the second opening 212 of the upper portion 115. For example, the attachment surface 220 may partially form or be defined within the internal space 230. As such the diameter of the bottom (e.g., in an operational orientation of the storage container 105) of the internal dome 230 may be similar to or the same as the second opening 212. The diameter of the bottom (e.g., in an operational orientation of the storage container 105) of the internal dome 230 may be between about (+/−10%) 1.5 inches and 4 inches. For example, the diameter of the bottom (e.g., in an operational orientation of the storage container 105) of the internal dome 230 may be 2.1 inches. A surface of the upper portion 115 of the storage container 105 that forms the internal space 230 may also define the hole of the spout 120.

In the assembled configuration 100, the lower portion 110 and the upper portion 115 may be coupled or otherwise attached. In the assembled configuration 100, the top panel 205 of the lower portion 110 may correspond with the bottom panel 215 of the upper portion 115. For example, the upper portion 115 may be a pyramid shape and the base of the pyramid shape may have a perimeter with the same dimensions as the perimeter of the lower portion surface 205, e.g., the base of the pyramid shape and the lower portion surface 205 may be 2.5 inches×2.5 inches squares. In the assembled configuration 100, the attachment member 225 and the attachment surface 220 may not be visible. For example, the lower portion 110 and the upper portion 115 of the storage container 105 may be or may include material that is opaque, such as cardboard or stainless steel. However, in an example with the lower portion 110 and the upper portion 115 of the storage container 105 including a material that is clear, such as glass or plastic, the lower portion 110 and the upper portion 115 may be visible in the assembled configuration 100.

The lower portion 110 and the upper portion 115 may be coupled with one another via the attachment member 225 and the attachment surface 220. Since surfaces of both the attachment member 225 and the attachment surface 220 may be threaded, the threads of the attachment member 225 may correspond or otherwise engage with the threads of the attachment surface 220. For example, the upper portion 115 may be placed over the lower portion 110 so as to align the first opening 210 and the second opening 212. Since the diameter of the second opening 212 may be slightly larger than the diameter of the first opening 210, the attachment surface 220 may snuggly engage with the outer surface of the attachment member 225. The upper portion 115 may be twisted relative to the lower portion 110 so as to facilitate engagement between the threads of the attachment surface 220 and the attachment member 225. The upper portion 115 and the lower portion 110 may be structured so as to facilitate coupling to each other via other mechanical methods besides threads. For example, the attachment surface 220 may snap onto the attachment member 225. Additionally or alternatively, the attachment surface 220 and the attachment member 225 may not be included and the lower portion 110 and the upper portion 115 may include magnet components so as to facilitate a magnetic coupling thereof.

The spout 120 and the cap 125 may be coupled with one another. Since surfaces of both the spout 120 and the cap 125 may be threaded, the threads of the spout 120 may correspond or otherwise engage with the threads of the cap 125. For example, the cap 125 may be placed over the spout 120 so as to align with the hole of the spout 120. Since the diameter of the cap 125 may be slightly larger than the diameter of the spout 120, the cap 125 may snuggly engage with the outer surface of the spout 120. The cap 125 may be twisted or turned so as to facilitate engagement between the threads of the spout 120 and the cap 125. The cap 125 and the spout 120 may be structured so as to facilitate coupling to each other via another method besides threads. For example, the cap 125 may snap onto the spout 120.

In the disassembled configuration 200, the lower portion 110 and the upper portion 115 are detached or otherwise uncoupled. Additionally, the spout 120 and the cap 125 may also be detached or otherwise uncoupled. In the disassembled configuration 200, the first opening 210 may be exposed. Additionally in the disassembled configuration 200, the spout 120 may also be exposed.

With reference to FIGS. 3A and 3B, additional configurations of the storage container 105 are shown. FIG. 3A illustrates the storage container 105 in a load configuration 300, which may also be referred to as a first use 300. FIG. 3B illustrates the storage container 105 in a dispense configuration 310, which may also be referred to as a second use 310. The storage container 105 is manipulateable or can transition between the load configuration 300 and the dispense configuration 310. For example, a user may manipulate or transition the storage container 105 between the load configuration 300 and the dispense configuration 310.

In the load configuration 300, the storage container 105 may receive the consumable 305 in the lower portion 110 via the first opening 210. For example, the lower portion 110 may receive a consumable 305 via the first opening 210 with the upper portion 115 uncoupled from the lower portion 110. The consumable 305 may be poured in or otherwise distributed to the storage container 105, e.g., the lower portion 110 of the storage container 105. For example, greater than or equal to about 62 ounces and less than or equal to about 66 ounces of the consumable 305 may be poured into the lower portion 110. The storage container 105 may be in the disassembled configuration 200 so as to expose the first opening 210. With the first opening 210 exposed, the consumable 305 may be poured through the first opening 210. Since the diameter of the first opening 210 may be about 2 inches (for example), additional tools such as a funnel may not be required. For example, the diameter of the first opening 210 may be sufficiently large enough to pour the consumable 305 into the lower portion 110 without spilling. Additionally, since the diameter of the first opening 210 may be about 2 inches (for example), the consumables 305 that are solid such as fruit, ice, or the like may be distributed into the lower portion 110. Since the diameter of the first opening 210 may be sufficiently large enough to allow the consumables 305 that are solid to pass through, the user may have more of a variety of options than if solid consumables could not fit into the storage container 105 via an opening.

In the dispense configuration 310, the storage container 105 may dispense the consumable 305 via the spout 120. For example, the upper portion 115 may dispense the consumable 305 via the spout 120 with the upper portion 115 coupled with the lower portion 110. In the dispense configuration 310, the upper portion 115 is received by the lower portion 110 and the lower portion 110 and the upper portion 115 are in fluid communication with each other. For example, the second opening 212 of the upper portion 115 is in fluid communication with the first opening 210 of the lower portion 110. The second opening 212 may dispense the consumable 305. For example, the second opening 212 may dispense at least a portion of the consumable 305 from the lower portion 110 to the spout 120, where the spout 120 may then dispense at least a portion of the consumable 305 out of the storage container 105. Thus, the second opening 212 may allow fluid communication between the spout 120 and the first opening 210.

The spout 120 may be large enough for the consumables 305 that are solid to pass through. For example, a user may pour a soup with ground beef through the spout 120. In another example, the diameter of the spout 120 may be such that prohibits the consumables 305 that are solid from passing through. For example, the diameter of the spout 120 may be large enough as to allow a liquid, such as water, through but small enough as to prohibit a solid, such as a lemon wedge, from passing through.

The internal space 230 of the upper portion 115 may help to direct the consumable 305 from the openings 210, 212 to the spout 120. For example, the surface that defines and/or forms the internal space 230 may help to prohibit the consumable 305 from distributing throughout other portions and/or spaces of the upper portion 115. In this example, the internal space 230 may help to keep the storage container 105 clean or otherwise sanitary since the internal space 230 provides a path for the consumable 305 to travel.

With reference to FIGS. 4A-4C and 6, a storage configuration 400 of the storage container 105 is disclosed. FIG. 6 additionally illustrates the storage container 105 in the storage configuration 400 in an environment 605. The environment 605 may be a freezer, a refrigerator, a cupboard, a countertop, or the like. For example, the storage container 105 may be stored in a variety of temperatures ranging from freezing to hot (e.g., the storage container 105 may be microwaved), including at room temperature. With the storage container 105 stored in the environment 605 in the storage configuration 400, the lower portion 110 and the upper portion 115 may be “stacked,” which may enable more efficient storage of the storage container 105 and the consumable 305. For example, the storage container 105 may require less space that a container that includes a spigot that uses additional storage space in the environment 605, e.g., the refrigerator.

The storage configuration 400 is similar to the assembled configuration 100 and the dispense configuration 310 in that the lower portion 110 and the upper portion 115 may be coupled. In the storage configuration 400, the consumable 305 may be stored in the storage container 105. For example, the consumable 305 may be stored in the lower portion 110 of the storage container 105. For example, the internal compartment of the lower portion 110 formed by the panels 130, 135, 140, 145, 150, 205 may hold the consumable 305. Additionally, the spout 120 and the cap 125 may be coupled in the storage configuration 400. With the cap 125 and the spout 120 coupled, the cap 125 may cover the spout 120 and prevent the consumable 305 from pouring through the spout 120 or otherwise dispensing from the storage container 105.

The storage container 105 may be manipulateable or transitioned between the load configuration 300 and the storage configuration 400. For example, the user may manipulate or transition the storage container 105 from the load configuration 300 to the storage configuration 400. The lower portion 110 may receive the consumable 305 (e.g., the user may pour the consumable 305 into the lower portion 110) via the first opening 210 with the upper portion 115 uncoupled from the lower portion 110. Then, in the storage configuration 400, the upper portion 115 is coupled with the lower portion 110. At least a portion of the consumable 305 may be stored within the lower portion 110. Additionally, the cap 125 may be coupled with the spout 120. The user may place the storage container 105 in the environment 605 with the storage container 105 in storage configuration 400. For example, the cap 125 may cover the spout 120 with the storage container 105 in the storage configuration 400 in which at least a portion of the consumable 305 is stored within the lower portion 110.

As depicted in FIGS. 4A-4C, the storage container 105 may receive different consumables. For example, the lower portion 110 of the storage container 105 may receive different consumables. The capability of the lower portion 110 to receive and thus store different consumables facilitates the reusable aspect of the storage container 105. For example in FIG. 4A, the lower portion 110 of the storage container 105 may receive and store a first consumable 405. The first consumable 405 may include a food such as fruit (e.g., lemon, cucumber, strawberry), soup, a smoothie, or the like. In FIG. 4B the lower portion 110 of the storage container 105 may receive and store a second consumable 410. The second consumable 410 may include a liquid such as water, milk, tea, alcohol, or the like. In FIG. 4C the lower portion 110 of the storage container 105 may receive and store a third consumable 415. The third consumable 415 may include a solid such as ice cubes, plastic ice cubes, a shaker ball, or the like. The storage container 105 may receive, store, and/or dispense the consumable 305, the first consumable 405, the second consumable 410, the third consumable 415, and/or any combination thereof. For example, the consumable 305 may include the properties of any or all of the first consumable 405, the second consumable 410, and the third consumable 415, and thus may be referred to interchangeably.

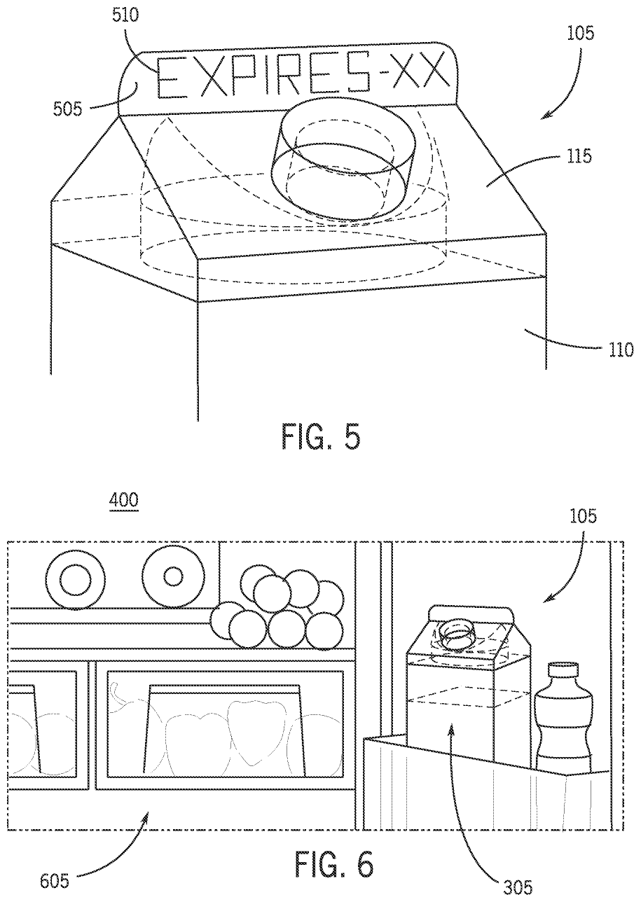

FIG. 5 illustrates a customizable surface of the storage container 105. The storage container 105 may include at least one customization surface 505. The storage container 105 and the surfaces thereof (e.g., the customization surface 505) may include a customization 510 or otherwise be customized. For example, the user may add the customization 510 to the storage container 105.

The customization surface 505 may be located or otherwise disposed on any surface of the storage container 105. For example, the customization surface 505 may be of at least one of the upper portion 115 and the lower portion 110. For example, the customization surface 505 may be located on a tab of the upper portion 115, as depicted in FIG. 5; on the front panel 130 of the lower portion 110; and/or on both the tab and the front panel 130. For example, the storage container 105 may include a plurality of customization surfaces 505.

The customization 510 may be related to information of the consumable 305. For example, the customization surface 505 may display information related to a liquid that the lower portion 110 of the storage container 105 is storing. The customization 510 may include a best consumed by/expiration date, a description of the consumable 305 (e.g., “Lemonade”), a source of the consumable 305 (e.g. “Grandma's lemonade”), or the like.

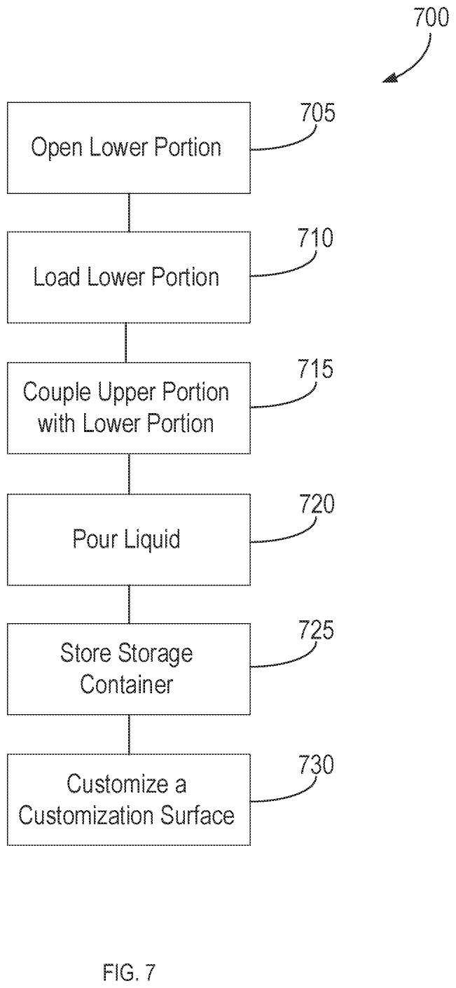

FIG. 7 illustrates a method 700 of using a storage container. Not every method steps of the method 700 described with reference to FIG. 7 must be included. Additionally, the method steps of the method 700 may be performed out of order or in a different order.

The storage container may be similar to or the same as the storage container 105. The method 700 may include opening the lower portion 110 (Step 705). Step 705 may facilitate and/or result in the storage container 105 being manipulated to the disassembled configuration 200. The lower portion 110 may be opened via uncoupling the upper portion 115 from the lower portion 110. Uncoupling the upper portion 115 from the lower portion 110 may expose the first opening 210. For example, the user may twist or pull the upper portion 115 and/or the lower portion 110 so as to disengage the attachment surface 220 from the attachment member 225.

The method 700 includes loading a lower portion of the storage container (Step 710). Step 710 may be similar to or the same as the load configuration 300 and the lower portion may be similar to or the same as the lower portion 110. For example, the method 700 may include loading the lower portion 110 of the storage container 105 with a liquid, for example the consumable 305, via the first opening 210. For example, the lower portion 110 may receive a consumable 305 via the first opening 210 with the upper portion 115 uncoupled from the lower portion 110. Since the diameter of the first opening 210 may be about 2 inches (for example), additional tools such as a funnel may not be required. For example, the diameter of the first opening 210 may be sufficiently large enough to pour the consumable 305 into the lower portion 110 without spilling.

The method 700 includes coupling an upper portion of the storage container with the lower portion (Step 715). Step 715 may facilitate and/or result in the storage container 105 being manipulated to the assembled configuration 100 and/or the storage configuration 400. The upper portion may be similar to or the same as the upper portion 115. For example, the lower portion 110 and the upper portion 115 may be coupled with one another via the attachment member 225 and the attachment surface 220. As such, the method 700 may include placing the upper portion 115 over the lower portion 110 so as to align the first opening 210 and the second opening 212. Since the diameter of the second opening 212 may be slightly larger than the diameter of the first opening 210, the attachment surface 220 may snuggly engage with the outer surface of the attachment member 225. The method 700 may include twisting the upper portion 115 so as to facilitate engagement between the threads of the attachment surface 220 and the attachment member 225. Additionally, the upper portion 115 and the lower portion 110 may be structured so as to facilitate coupling to each other via another method besides threads. For example, the method 700 may include snapping the attachment surface 220 onto the attachment member 225.

The method 700 includes pouring the liquid from the upper portion of the storage container (Step 720). Step 720 may be similar to or the same as the dispense configuration 310. For example, the upper portion 115 may dispense the consumable 305 via the spout 120 with the upper portion 115 coupled with the lower portion 110. The method 700 may include pouring the liquid from the storage container 105 via a spout extending from the upper portion 115. The spout may be similar to or the same as the spout 120. For example, the spout 120 may extend from the upper portion 115 and be in fluid communication with the first opening 210 and the second opening 212. The spout 120 may be large enough for a consumable 305 that is solid to pass through.

The method 700 may include storing the storage container (Step 725). Step 725 may facilitate and/or result in the storage container 105 being manipulated to the storage configuration 400. For example, the method 700 may include storing the storage container 105 in an environment with at least a portion of the consumable 305 stored within the lower portion 110. The environment may be similar to or the same as the environment 605. For example, the storage container 105 may be stored in a variety of temperatures ranging from freezing to hot (e.g., the storage container 105 may be microwaved), including at room temperature.

The method 700 may include customizing a customization surface of at least one of the upper portion and the lower portion (Step 730). The customization surface may be similar to or the same as the customization surfaces 505. For example, the customization surface 505 may be located or otherwise disposed on any surface of the storage container 105 and may include the customization 510 or otherwise be customized. The customization 510 may be related to information of the consumable 305, e.g., the expiration date, the description, the source, or the like.

The description of certain embodiments included herein is merely exemplary in nature and is in no way intended to limit the scope of the disclosure or its applications or uses. In the included detailed description of embodiments of the present systems and methods, reference is made to the accompanying drawings which form a part hereof, and which are shown by way of illustration specific to embodiments in which the described systems and methods may be practiced. These embodiments are described in sufficient detail to enable those skilled in the art to practice presently disclosed systems and methods, and it is to be understood that other embodiments may be utilized, and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The included detailed description is therefore not to be taken in a limiting sense, and the scope of the disclosure is defined only by the appended claims.

From the foregoing it will be appreciated that, although specific embodiments of the invention have been described herein for purposes of illustration, various modifications may be made without deviating from the spirit and scope of the invention.

The particulars shown herein are by way of example and for purposes of illustrative discussion of the preferred embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice.

As used herein and unless otherwise indicated, the terms “a” and “an” are taken to mean “one”, “at least one” or “one or more”. Unless otherwise required by context, singular terms used herein shall include pluralities and plural terms shall include the singular. The term “about” herein is to be construed as +/−10%, unless stated otherwise. Every range of values (of the form, “from about a to about b,” or, equivalently, “from approximately a to b,” or, equivalently, “from approximately a-b”) disclosed herein is to be understood to set forth every number and range encompassed within the broader range of values.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

Of course, it is to be appreciated that any one of the examples, embodiments or processes described herein may be combined with one or more other examples, embodiments and/or processes or be separated and/or performed amongst separate devices or device portions in accordance with the present systems, devices and methods.

Finally, the above discussion is intended to be merely illustrative of the present system and should not be construed as limiting the appended claims to any particular embodiment or group of embodiments. Thus, while the present system has been described in particular detail with reference to exemplary embodiments, it should also be appreciated that numerous modifications and alternative embodiments may be devised by those having ordinary skill in the art without departing from the broader and intended spirit and scope of the present system as set forth in the claims that follow. Accordingly, the specification and drawings are to be regarded in an illustrative manner and are not intended to limit the scope of the appended claims.

What is claimed is:

1. A storage container comprising:
a lower portion defining a first opening, the lower portion configured to hold a liquid;
an upper portion received by and in fluid communication with lower portion, the upper portion defining a second opening; and
a spout extending from the upper portion, wherein when the upper portion and lower portion are coupled together in an assembled configuration, at least a portion of the liquid can be poured from the spout of the storage container.

2. The storage container of claim 1, wherein the first opening is a threaded opening.

3. The storage container of claim 1, wherein the second opening is a threaded opening.

4. The storage container of claim 1, comprising:
a cap to cover the spout, the cap to prevent the liquid from pouring through the spout.

5. The storage container of claim 1, comprising:
a customization surface of at least one of the upper portion and the lower portion, the customization surface to display information related to the liquid.

6. The storage container of claim 1, wherein the storage container is reusable and the lower portion is configured to receive a different liquid.

7. The storage container of claim 1, wherein:
the lower portion to receive the liquid via the first opening;
the upper portion to dispense the liquid via the spout;
the first opening is larger than the spout.

8. The storage container of claim 1, wherein the first opening is larger than the spout and the storage container is manipulateable between:
a first use in which the lower portion to receive the liquid via the first opening with the upper portion uncoupled from the lower portion; and
a second use in which the upper portion to dispense the liquid via the spout with the upper portion coupled with the lower portion.

9. The storage container of claim 1, wherein the storage container is manipulateable between:
a load configuration in which the lower portion to receive a liquid via the first opening with the upper portion uncoupled from the lower portion; and
a storage configuration in which the upper portion is coupled with the lower portion.

10. A reusable storage container, comprising:
a lower portion defining a first opening to receive a liquid; and
an upper portion to couple with the lower portion, the upper portion defining a second opening in fluid communication with the first opening, the second opening to dispense the liquid.

11. The reusable storage container of claim 10, wherein the reusable storage container is manipulateable between:
a first use in which the reusable storage container to receive the liquid in the lower portion via the first opening; and
a second use in which the reusable storage container to dispense the liquid via a spout extending from the upper portion.

12. The reusable storage container of claim 10, wherein the reusable storage container is manipulateable between:
a load configuration in which the lower portion to receive the liquid via the first opening; and
a storage configuration in which the upper portion is coupled with the lower portion with at least a portion of the liquid stored within the lower portion.

13. The reusable storage container of claim 10, comprising:
a spout extending from the upper portion, the second opening configured to allow fluid communication between the spout and the first opening.

14. The reusable storage container of claim 13, wherein at least a portion of the liquid can be poured from the spout of the storage container.

15. The reusable storage container of claim 13, comprising:
a cap to cover the spout with the reusable storage container in a storage configuration in which at least a portion of the liquid is stored within the lower portion.

16. A method of using a storage container comprising:
loading a lower portion of the storage container with a liquid via a first opening;
coupling an upper portion of the storage container with the lower portion; and
pouring the liquid from the upper portion of the storage container.

17. The method of claim 16, wherein prior to loading the lower portion with the liquid, the method comprising:
opening the lower portion via uncoupling the upper portion from the lower portion to expose the first opening.

18. The method of claim 16, the method comprising:
storing the storage container in an environment with at least a portion of the liquid stored within the lower portion.

19. The method of claim 16, the method comprising:
pouring the liquid from the storage container via a spout extending from the upper portion.

20. The method of claim 16, the method comprising:
customizing a customization surface of at least one of the upper portion and the lower portion with information related to the liquid.
